(19) United States
(12) Patent Application Publication
(10) Pub. No.: US 2017/0191286 A1
(43) Pub. Date: Jul. 6, 2017

(54) FENCE EDGING SYSTEM

(71) Applicant: Raymond Henry Rudolph, Houston, TX (US)

(72) Inventor: Raymond Henry Rudolph, Houston, TX (US)

(21) Appl. No.: 15/147,466

(22) Filed: May 5, 2016

Related U.S. Application Data
(60) Provisional application No. 62/274,419, filed on Jan. 4, 2016.

(51) Int. Cl. E04H 17/06; A01G 1/08

(52) U.S. Cl. CPC E04H 17/063; A01G 1/08

(57) ABSTRACT

A system and method for the suppression of vegetation growth under fencing and the prevention of premature rotting is presented. The system includes moisture resistant edging blocks configured to rest between the fencing and the ground. The blocks include a lower surface for resting on the ground and an upper surface adjacent to a lower portion of the fence. The system includes a plurality of blocks selectively routed and interlocked together. The blocks may optionally include a notch to permit the full enclosure of the fence post, a groove to permit selective routing of exterior fluid lines and electrical lines along the fence, and a hollowed channel for interlocking neighboring blocks together.

### CLAIM OF PRIORITY

This application claims the benefit of U.S. Provisional Application No. 62/274,419, filed 4 Jan. 2016. The information contained therein is hereby incorporated by reference.

### BACKGROUND

1. Field of the Invention

The present application relates to an outdoor edging system, and more particularly to a system of edging blocks used to rest between a fence and the soil.

2. Description of Related Art

Fencing are commonly used to define property boundaries. Fencing can come in many different types and are varied depending on their use. In residential situations, fencing usually defines a yard. These fences are typically 6 feet in height and either contact the ground or are in close proximity to the ground. A common fencing product is wood. It is easy to use and customizable by a homeowner. However, wood fencing can be susceptible to rot from moisture around the ground. In order to avoid rot, other fencing products may be used, such as a plastic resin or metal fence product.

A common issue for all types of fencing is the need to trim and maintain the vegetation around the fence. Grass is commonly used as a ground cover for its comfort on the feet and durability to traffic. Grass and other vegetation can grow up and around fencing, requiring their trimming. Traditional lawn mowers can't cut grass next to the fences. Weed trimmers are often used to get the close vegetation. A disadvantage of using weed trimmers is the abuse given to the fencing.

One method has been used to try and correct for the potential rot and damage from weed trimmers that plague fencing; that is the use of a sacrificial board. In the case of wooden fencing, sometimes a separate board will be secured to a lower portion of the fence panels to absorb the abuse from the weed trimmer and to minimize the visual unsightliness common with rotting. This board is attached to the fence itself and over time can move in relation to the fence. Additionally, vegetation under the sacrificial board is still permitted to grow and can almost increase the difficulties in trimming vegetation.

Although strides have been made to fencing, a new system and method is needed to help prevent moisture from reaching fencing panels from the ground and provides additional benefits, minimizing vegetation growth under fences, and provide protection from trimming equipment.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a fence edging system according to an embodiment of the present application.

FIG. 2 is a perspective view of an edging block in the fence edging system of FIG. 1.

FIG. 3 is an end view of the edging block of FIG. 2.

FIG. 4 is a perspective view of a second edging block in the fence edging system of FIG. 1.

FIG. 5 is a perspective view of an alternative embodiment of the edging block of FIG. 2.

FIG. 6 is an end view of the edging block of FIG. 5.

FIG. 7 is a perspective view of an alternative embodiment of the second edging block of FIG. 4.

FIG. 8 is a perspective view of an alternative embodiment of the edging block of FIG. 2.

FIG. 9 is an end view of the edging block of FIG. 8.

FIG. 10 is a perspective view of a pin used in association with the edging block of FIG. 8.

FIG. 11 is a top view of a pivoting pin used in association with the edging block of FIG. 8.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the system is depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the system described herein may be oriented in any desired direction.

The system and method in accordance with the present application overcomes one or more of the above-discussed problems commonly associated with traditional methods of fencing. In particular, the system is configured to rest beneath a fence without attachment to the pickets and/or panels so as to deter vegetation growth and deter moisture transference to the fence. The system is configured to adapt and be sized to fit various panel widths. The system is configured to create an interconnected line of edging bricks that follows a line of fencing. The bricks may be configured to be grooved so as to accept fluid and/or electrical lines. These and other unique features of the system are discussed below and illustrated in the accompanying drawings.

The system and method will be understood, both as to its structure and operation, from the accompanying drawings, taken in conjunction with the accompanying description. Several embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system and method of the present application is illustrated in the associated drawings. The fence edging system includes a first edging block and a second edging block. The first edging block is configured to have a lower surface and an upper surface. The second edging block is in communication with the first edging block and likewise includes a lower surface and an upper surface. The blocks are configured to interlock in a manner and reside between a lower portion of a fence panel and the ground. The blocks are configured to suppress vegetation growth below the lower surface and resist moisture absorption. The blocking of moisture from reaching the fence panels helps to increase the life expectancy of the fence panels. The blocks are configured to operate without attachment to the fence panel itself. Additional features and functions of the system are illustrated and discussed below.

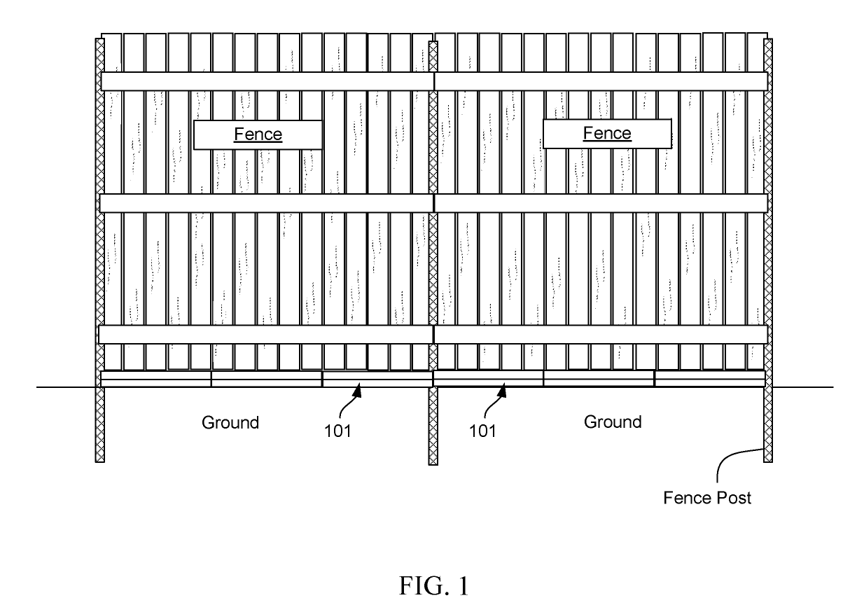

Referring now to the drawings wherein like reference characters identify corresponding or similar elements in form and function throughout the several views. FIG. 1 illustrates a side view of fence edging system 101 according to an embodiment of the present application. System 101 is composed of one or more blocks configured to be set in a relatively linear manner, end to end, and reside underneath the panels of a fence. As seen in the figure, the blocks are configured to accommodate fence posts. Use of system 101 suppresses vegetation growth beneath the fence to allow for a more simplified process of trimming grasses and other vegetation adjacent the fence.

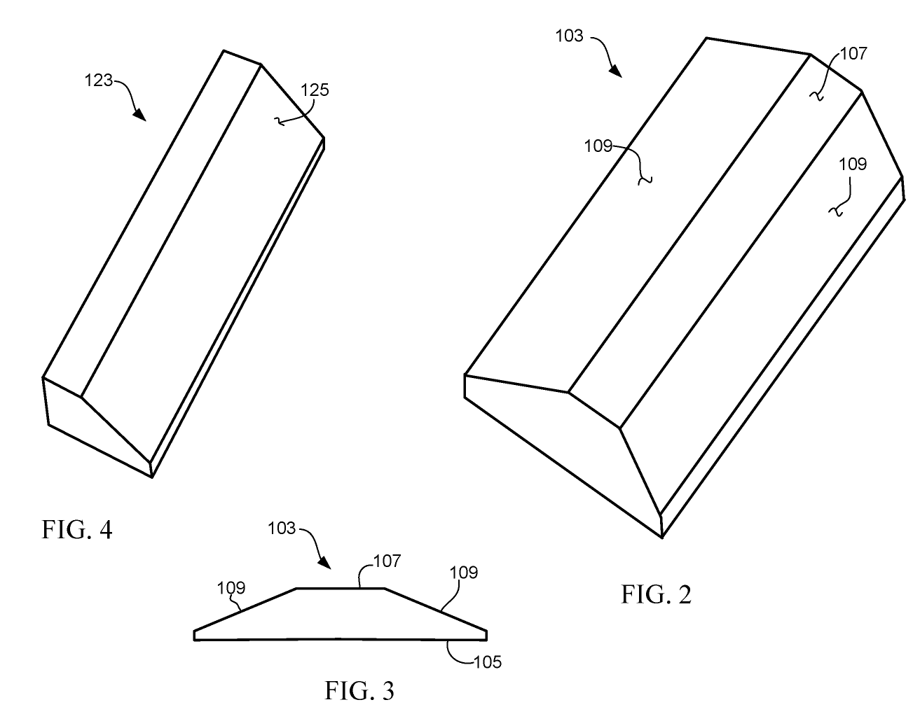

Referring now also to FIGS. 2 and 3 in the drawings, a perspective view and end view of an edging block, respectively, in system 101 is illustrated. Edging block 103 is a relatively rigid singular member made from a moisture resistant material. Examples may include a composite material, metallic alloy, and rubberized material. Block 103 has an upper surface 107 and a lower surface 105. Surface 105 is configured to rest on the ground while surface 107 is configured to abut a lower portion of a fence panel. Contact between surface 107 and the fence panel may or may not be made. Block 103 has a selected width and length. The length of block 103 may be preselected at any length and is not herein limiting. A user may selectively adjust the length of block 103 to accommodate environmental conditions, including fence post separation distance and fence routing to name a few. The width is selected ideally to be as wide as the thickness of the fence, including the fence post and fence panel. This allows trimming equipment, such as mowers and trimmers, to pass along the sides of the fence without having to maneuver in between fence posts or trim under the fence panel.

Referring now also to FIG. 4 in the drawings, a perspective view of a second or alternative edging block 123. Block 123 is similar in form and function to that of block 103 including having an upper surface and lower surface, along with a defined length and width. Block 123 differs in that its width is relatively half that of block 103. In particular, whereas block 103 includes sloped surfaces 109, block 123 includes only a single sloped surface 125. Block 123 is useful in situations wherein space is limited under the fence panel. Sloped surfaces 109 and 125 are useful in that the deck of a mower may be configured to pass over a portion of the edge so as to permit the blade of the mower to fully trim grasses up against system 101. The specific height and slope of surfaces 109 and 125 may be selected during production or modified by the user after purchase.

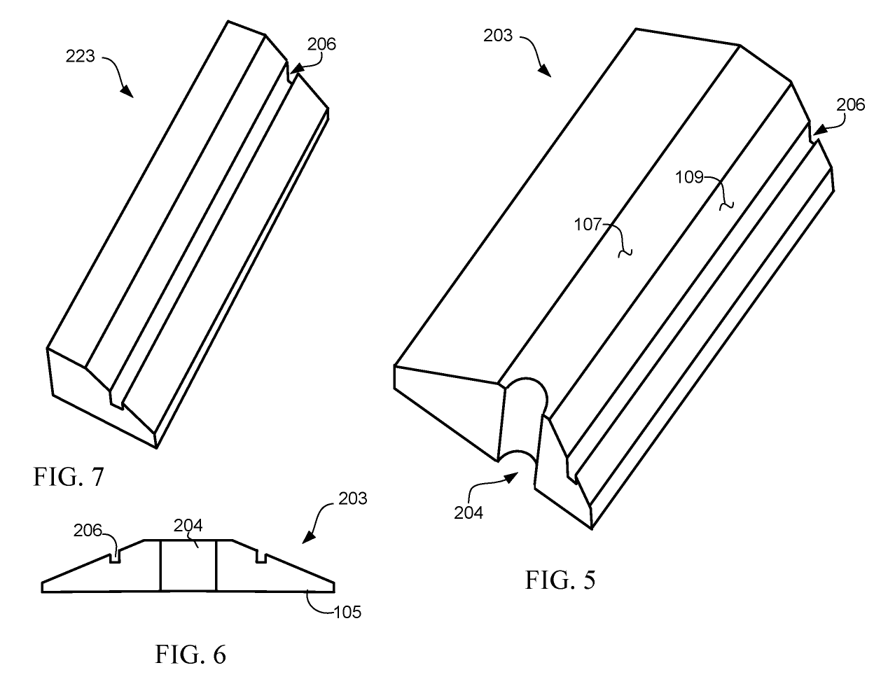

Referring now also to FIGS. 5 and 6 in the drawings, a perspective view and an end view, respectively, of an alternative embodiment of block 103 is illustrated. Block 203 is similar in form and function to that of block 103 except as herein noted with respect to a few optional features. Block 203 optionally includes a notch 204 along a first end 206. The notch 204 is configured to pass between and through the upper surface and the lower surface. Notch 204 is configured to be shaped so as to conform and accommodate the contour of the fence post. The size and depth of notch 204 is such that it is as deep as half the thickness of the fence post. This allows separate individual blocks 203 to be located at either end of the fence post and provide coverage around the entire circumference. It is understood that the size and shape of notch 204 may be varied to accommodate different types of fence posts. For example, an aluminum fence post is rounded while a wooden fence post is relatively square. The user is able to rework or modify the dimensions of notch 204 and block 203 as necessary to form a desired fit.

Additionally, block 203 may optionally further include groove 206. Groove 206 is located along an exterior surface of block 203. For example, surface 109 is ideally suited for groove 206. Other surfaces are possible and considered within the scope of the present application. Groove 206 is configured to accept at least one of an electrical line and a fluid line to allow for the ease of routing plumbing and/or conduit through the yard. For example, gardens or flower beds are often found abutting a fence line. Plumbing lines may be routed through groove 206 and partitioned off at selected locations to ensure proper coverage of moisture. Additionally, conduit or electrical lines may be routed so as to provide accent lighting within the yard. It is assumed that groove 206 runs the full length of block 203 as shown, however it is not so limited. Groove 206 may be any length and extend to any length along block 203. Furthermore, groove 206 may be located on any surface of block 203. FIG. 6 is an end view wherein for illustration purposes, an additional groove 206 is shown compared to that of FIG. 5.

Referring now also to FIG. 7 in the drawings, a perspective view of an alternative embodiment of block 123 is illustrated. Block 223 is similar in form and function to that of block 123 except as herein noted with respect to an additional feature. Block 223 is configured to optionally include groove 206. The same limitations and features of groove 206 described with block 203 apply equally to that of block 223. Although not depicted, it is conceived that block 223 may optionally include a notch similar to that of notch 204 except wherein the notch would be formed to include less than half the circumference or outer surface area of the fence post. In this way, block 223 may be used to accommodate situations where the fence line splits at various angles.

It is understood that although block 203 has been described with notch 204 being half the surface area of the fence post, some situations may permit that notch 204 may be actually trimmed to be less than half the surface area around the fence post. In this situation, block 203 may be trimmed such that the overall overhead rectangular shape is chamfered so as to eliminate a corner. The chamfer may extend into notch 204.

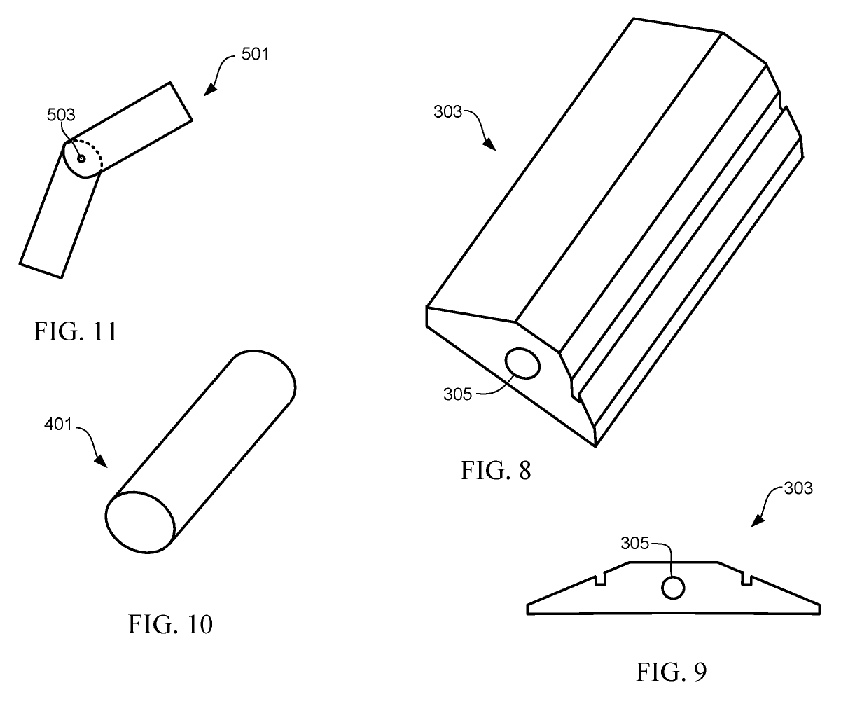

Referring now also to FIGS. 8 and 9 in the drawings, a perspective view and an end view, respectively, of an alternative embodiment of block 103 is illustrated. Edging block 303 is similar in form and function to that of block 103 and additionally the functions and features of block 203. A main difference in block 303 is the optional inclusion of a hollowed channel 305. The blocks of system 101 are configured to selectively interlock to ensure continuous contact with each other. Such interlocking is also selectively detachable to allow for adjustment or modification. Channel 305 passes through the interior of block 303. Channel 305 may pass completely from end to end or may be configured to stop at a selected depth. Channel 305 is configured to accept a male connector to create the interlocking connection with a neighboring edging block. In some embodiments, the neighboring edging block may integrally include the necessary male connector as a protrusion from one end. A more universal and versatile type of male connector is that wherein the male connector is its own independent member.

Referring now also to FIGS. 10 and 11 in the drawings, two different embodiments of the male connector are illustrated. The male connector may be a connector pin 401 as seen in FIG. 10. Pin 401 is configured to engage channel 305 within two neighboring edging blocks. In this manner, pin 401 is inserted into both channels a predetermined distance so as to secure their respective positions relative to each other. As seen in FIG. 10, pin 401 is a single rigid member. Such is most useful for linear connections. Although channel 305 is shown as being linear and perpendicular to first end 206, it is understood that other angles and routes may be used.

As seen in FIG. 11, connector pin 501 is illustrated wherein this pin is a multi-piece member configured to articulate about an axis 503. The articulation allows for the maintaining of linear channels 305 while permitting for the angled orientation of neighboring blocks relative to one another. For example, a change in slope may necessitate a change in the overall axis of the male connector. Therefore, pin 501 would be able to accommodate such need. Additionally, wherein the blocks are trimmed or chamfered to accommodate changes of direction in the routing of the blocks, pin 501 is configured to adjust its axial direction to maintain engagement with channel 305.

It is understood that the use of channel 305, groove 206, and notch 204 may be optionally incorporated into any of blocks 103, 203, and 303. The male connectors are not herein limited to that shown in the figures. Other types of connectors are conceived of and considered within the scope of the present application.

The current application has many advantages over the prior art including at least the following: (1) an ability to prevent vegetation growth beneath fencing; (2) an ability to avoid moisture collecting beneath the fencing and causing premature rot; (3) an ability to adjust the orientation of the blocks while maintaining an interlocking nature; and (4) an ability to incorporate a groove and notch.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An edging system for a fence, comprising:
a first edging block configured to have a lower surface and an upper surface; and
a second edging block in communication with the first edging block, the second edging block a lower surface and an upper surface, the second edging block configured to abut a portion of the first edging block;
wherein the first edging block and the second edging block are configured to suppress vegetation growth below the lower surface and resist moisture absorption.

2. The edging system of claim 1, wherein the upper surface of the first edging block and the second edging block are configured to abut a lower surface of a fence panel.

3. The edging system of claim 1, wherein the first edging block further includes a notch along a first end, the notch passing through the first edging block from the upper surface to the lower surface.

4. The edging system of claim 1, wherein the first edging block further includes a groove, the groove being located along an exterior surface.

5. The edging system of claim 4, wherein the groove is configured to pass along the full length of the first edging block.

6. The edging system of claim 4, wherein the groove is configured to accept at least one of an electrical line and a fluid line.

7. The edging system of claim 1, wherein the first edging block and the second edging block are configured to selectively interlock to ensure continuous contact with each other.

8. The edging system of claim 7, wherein the interlocking feature of the first edging block and the second edging block are detachable.

9. The edging system of claim 1, wherein the first edging block further includes a hollowed channel.

10. The edging system of claim 9, wherein the hollowed channel passes through the first edging block from a first end to a second end.

11. The edging system of claim 9, wherein the hollowed channel is configured to accept a male connector to create an interlocking connection with the second edging block.

12. The edging system of claim 11, wherein the male connector is integrally formed onto the second edging block.

13. The edging system of claim 9, further comprising:
a connector pin configured to engage the first edging block within the hollowed channel.

14. The edging system of claim 13, wherein the connector pin is a singular rigid member.

15. The edging system of claim 13, wherein the connector pin is a multi-piece member configured to articulate about an axis.

16. The edging system of claim 9, wherein the length of the first edging block is customizable to a desired length, the hollowed channel remaining within the first edging block after adjustment of the length.
